(19) United States
(12) Patent Application Publication
(10) Pub. No.: US 2003/0065477 A1
(43) Pub. Date: Apr. 3, 2003

(54) Two-sample permutation tests

(76) Inventor: John D. Opdyke, Brookline, MA (US)

Correspondence Address: ROPES & GRAY, ONE INTERNATIONAL PLACE, BOSTON, MA, 02110-2624, US

(21) Appl. No.: 09/944,249

(22) Filed: Aug. 30, 2001

(51) Int. Cl. G06F 15/00; G06F 17/18; G06F 101/14

(52) U.S. Cl. 702/179

(57) ABSTRACT

A statistical program for performing two-sample permutation tests comparing continuous- or count-variable means, even when one of the sample sets is small and the other is large. The program greatly reduces computer runtime over previous attempts at the problem, and unlike previous attempts maximizes the statistical power of the permutation test through a specific sampling technique while correctly maintaining the exact-test properties of a permutation test.

### BACKGROUND OF THE INVENTION

Two-sample hypothesis tests have been used for many decades to infer whether two populations of data differ. While suitable statistical and computational techniques have been devised for comparing two small data samples, and for comparing two large data samples, there remains a need for statistically powerful and computationally efficient approaches for comparing two samples when one is small but the other is large, especially when many repeated comparisons are required over time.

### SUMMARY OF THE INVENTION

There are disclosed herein methods and systems for performing two-sample permutation tests that compare continuous- or count-variable means, even when one of the samples is large.

Accordingly, the present invention described herein provides a process for comparing two data samples comprising obtaining a first data sample, having a first number of data points, obtaining a second data sample, having a second number of data points, processing the first and second data samples to determine a t-statistic, Z-statistic, or respective measures of observed means or sums and the difference between the observed means or sums (depending on the test statistic selected by the user), selecting data points from the first data sample and the second data sample to generate a plurality of sample pairs combining data points from the first and second data samples and having a number of data points comparable to the numbers in the first data sample and the second data sample, calculating and ranking the t-statistics, Z-statistics, or differences of means or sums for the generated pairs of samples, and calculating a P-value by determining the percentage of the t-statistics, Z-statistics, or differences of means or sums of the generated sample sets that are as large as the respective statistic or difference of the original sample pair, and repeating this process for a large number (thousands) of sample pairs (typically, many small samples compared to a fewer number of large samples).

The permutation test process described herein is applicable when the number of data points in at least one of the two samples is small and insufficient in size to rely upon the Central Limit Theorem when making inferences about the possible difference between the two population means based on the two sample means—the goal of the permutation test. Typically, the rule of thumb that may be applied is that a data sample having less than thirty data points is insufficient in size to apply the Central Limit Theorem. As is known to those of skill in the art, the Central Limit Theorem states that for distributions with finite variance the distribution of the sample mean will approach the normal distribution as the sample size increases. The more normally distributed the data, the smaller the sample size required for the distribution of the sample mean to closely approximate the normal distribution. Unless the data is exactly normally distributed, which only occurs under controlled circumstances, the sample means of samples of less than thirty data points will not be normally distributed. Consequently, the normal distribution, and the Central Limit Theorem, may not be used as a basis for making statistical inferences about the population mean based upon the sample mean, nor the difference between two population means based on the difference between two sample means, since the distribution of the difference will converge to normality as sample sizes increase just as does the distribution of a single sample mean.

In practice, the process includes generating a plurality of data sample pairs based on the combined data points of the first and second samples of each sample pair wherein “oversampling” is employed to generate unique sets of corresponding permutation sample pairs, thus maximizing the statistical power of each permutation test on each of the original sample pairs.

The process further includes techniques for more efficiently processing the data as compared to prior art (well over an order of magnitude reduction in computer runtime, from days to hours, as described below). These techniques include identifying preprogrammed utilities for performing multiple operations simultaneously, thereby reducing computational time. The performing of multiple operations include utilizing preprogrammed software procedures that of perform multiple operations in a single pass. Additionally, the preprogrammed software procedures include software procedures selected from the group of languages including SAS. Additionally, the step of processing the generated pairs of data samples includes generating a string of strings of data set names to combine the data samples.

In the process, the selecting of data samples to generate a plurality of sample sets includes determining a statistically appropriate number of sample pairs to generate. The determination of a statistically appropriate number follows from principles known in the art of statistical analysis and includes a mathematical formula that makes this determination as a function of the coefficient of the variation of the result of the permutation test.

Additionally, the selecting of data samples includes applying a random sampling procedure to select data points from both the first and second samples in each sample pair for the purpose of generating corresponding sets of “permutation” data samples from the combined points of each sample pair. This selecting step includes the use of a nested macro to overcome a numeric size constraint of the random sampling procedure employed to select the data points in the samples.

The process described herein further includes a data merging operation that identifies characteristics of the merge and selects a merging method for reducing computer runtime for merging the data. In addition, the process includes macro calls and nested macro calls that replace more time-consuming iterations in an expanded series of inline steps. Furthermore, the process includes identifying the need for multiple iterations through a series of program steps for processing a dataset and replacing the expanded series of inline steps with a loop on an array of multiple variables.

The process described above can be employed with a number of different types of test statistics as selected by the user, including, for continuous data, the pooled-variance t-test, the separate variance t-test, and the “modified” Z-test,¹ and for count data, the normal approximate Poisson test. ¹ See Brownie, et al, Modifying the t and ANOVA F tests When Treatment is Expected to Increase Variability Relative to Controls, Biometrics, March, 1990; and Blair, R. Clifford and Shlomo Sawilowsky, Comparison of Two Tests Useful in Situations where Treatment is Expected to Increase Variability Relative to Controls, Statistics in Medicine, Vol. 12, 2233-2243, John Wiley & Sons, Ltd., 1993.

Additionally, the processes include testing the samples among the multiple pairs of permutation data samples generated to identify those in the typically larger sample of the pair (based on the modified null hypothesis for the “modified” Z-test) having a variance of zero, thereby allowing the implementation of the “modified” Z-test when, due to division by zero, it would otherwise be impossible to calculate.

In additional aspects, the invention provides inventive systems for comparing two data samples, as well as a computer readable medium that stores instructions for directing a computer processing platform to implement a process according to the invention.

Other systems, methods and applications of the inventive subject matter disclosed herein will be apparent to those with skill in the art and shall be understood to fall within the scope of the invention.

### DETAILED DESCRIPTION OF THE ILLUSTRATED EMBODIMENT

This systems and method described herein provide a new method for quickly performing permutation tests comparing two continuous- or count-variable sample means, even when one of the samples is large (if one sample is relatively small (less than 30 observations), the size of the large sample can be at least millions of observations). The Central Limit Theorem states that for distributions with finite variance (almost all statistical distributions), the distribution of the sample mean will approach the normal distribution (a.k.a. “the bell curve”) as the sample size increases. The more normally distributed the data, the smaller the sample size required for the distribution of the sample mean to closely approximate the normal distribution. Unless the data is exactly normally distributed (which only occurs under controlled circumstances), the sample means of samples of less than 30 observations will not be normally distributed. Consequently, the normal distribution (and the Central Limit Theorem) cannot be used as a basis for making statistical inferences about the population mean based on the sample mean, nor the difference between two population means based on the difference between two sample means, since the distribution of the difference will converge to normality as sample sizes increase just as does the distribution of a single sample mean. To this end, the system described herein first checks the sizes of each sample in every pair submitted for processing and retains only those where one of the samples in the pair has fewer than 30 observations. The system then employs the process to test a null hypothesis of the mean of the (typically) larger sample being equal to or less than that of the smaller sample, against the alternate hypothesis that the mean of the smaller sample is larger (a “one-tailed” test). The process is easily adapted to perform a “two-tailed” hypothesis test where the null hypothesis is equal means and the alternate hypothesis is unequal means (where the mean of the smaller sample can be larger OR smaller than that of the larger sample). Although the embodiment described herein includes code that was written in the SAS programming language, it is understood that it may be adaptable to other programming languages as well. Though the code can be applied in any context requiring permutation tests, one area where it proves especially useful is telecommunications Operations Support Systems parity testing. It will be appreciated that this example is provided as an illustration, and should not be interpreted in a limiting sense.

The Telecommunications Act of 1996 requires Regional Bell Operating Companies (RBOCs) to open their local phone service monopolies to competition if they are to be allowed to provide long distance phone service (prohibited since the government-mandated break-up of the AT&T monopoly in 1984). A local phone service market is deemed competitive when the RBOC can prove it has been providing local phone service to its competitors' customers that is equivalent to the service it provides to its own customers. Comparing the average service times (average time to install a line; average time to repair a line, etc.) that an RBOC provides its own customers vs. its competitors' customers requires thousands of two-sample comparisons, often when one sample (the competitors' customers) is very small and the other (the RBOC's own customers) is very large (sometimes many millions of customers). The typically small size of the one sample makes a permutation test the appropriate statistical test to use when making the comparison (other statistical tests are precluded from use under these conditions because the distributional assumptions they rely upon are violated by small sample sizes), but the often large size of the other sample makes a permutation test computationally very difficult to implement quickly enough to be a viable method of comparison.

A brief and general description of a permutation test comparing continuous- or count-data means includes the steps below:

i. Calculate Difference of Two Sample Means:

Calculate the means of each of the two samples being compared, and then calculate their difference.

ii. Pool the Two Samples:

Create one large sample by pooling the data from the two samples being compared.

iii. Relabel the Pooled Sample:

Randomly relabel all the data points in the pooled sample as coming from sample 1 or sample 2, creating a new pair of similarly-sized samples, or a “permutation sample pair.”

iv. Calculate the Difference of Two Permutation Sample Means:

Calculate the means of each sample in the permutation sample pair, and then calculate their difference.

v. Create Multiple Permutation Sample Pairs and Calculate Each Difference in Means:

Repeat steps iii and iv for all possible combinations of sample pairs, and calculate the difference in means of all of these sample pairs. Optionally, when the number of possible combinations is very large, randomly choose a number (K) of these sample pairs (the determination of K is described below).

vi. Rank Order the Differences of Permutation Sample Means:

Order the differences in means of all of the permutation sample pairs, for example, from smallest to largest.

vii. Compare Original Difference in Sample Means with Differences of Multiple Permutation Sample Means:

Determine the percentage of the differences in means from the multiple permutation sample pairs that are at least as large as the difference in means from the original sample pair. This percentage is the “p-value,” and is the result of the test. A small p-value below the significance level of the test (typically the significance level α=0.05, and can be specified by the user in the present invention) allows rejection of the null hypothesis of equal means, because the observed difference in means is larger than 95% (or more) of all possible differences in means. A larger p-value does not allow rejection of the null hypothesis, because the observed difference in means is not larger than almost all of the possible differences in means, and random variation cannot be rejected as the source of whatever difference is observed in the original sample pair.

The above steps describe a one-tailed test where the alternate hypothesis is that one of the samples (sample 1 if difference=[sample 1−sample 2], and sample 2 if the difference=[sample 2−sample 1]) is larger than the other, and the null hypothesis is that the other sample is equal to or smaller than the first. The null hypothesis is the status quo that any classical hypothesis test is trying to disprove (e.g., equality of means), while the alternate hypothesis is accepted when the null hypothesis is rejected. The null and alternate hypotheses must be mutually exclusive and exhaustive. For a two-tailed test, where the alternate hypothesis may be defined as unequal means and the null hypothesis may be equal means, very small OR very large p-values (for example, as small as p-value=0.025 or as large as p-value=0.975) allow for rejection of the null hypothesis. This will be apparent to those of skill in the art as the observed difference in means is very different from almost all of the possible differences in means. The closer the p-value is to 0.50, the more “typical” is the difference in means—closer to the center of the distribution of all possible sample mean differences—and random sampling variation should not be ruled out as the possible source of the observed difference in the original sample pair. The effect of random sampling variation will be understood by those of skill in the art and is described in the literature, including Efron, Bradley and Robert J. Tibshirani, An Introduction to the Bootstrap, CRC Press, LLC (1994); Mielke, Paul W., and Kenneth J. Berry, Permutation Methods—A Distance Function Approach, Springer (2001); and Pesarin, Fortunato, Multivariate Permutation Tests with Applications in Biostatistics, Wiley (2001); the contents of these publications being incorporated by reference herein.

Also, the above steps describe an implementation of a permutation test based on a pooled-variance t-test. Because the pooled-variance used in calculating the t-statistic is identical in every permutation sample pair, only the relative order of the means (and simpler still, just the relative order of the sums, since the sample sizes (the denominator of the means) do not vary from sample to sample) needs to be determined—the t-statistic does not need to be calculated for every sample pair. When based on other statistics, however, such as the ‘modified’ Z-test (described below), the permutation test must calculate the full statistic when rank-ordering the results and determining the p-value. The systems and processes described herein are designed to implement a permutation test using any of several different statistics, as selected by the user, where the selection may vary according to the application.

The present invention described herein surmounts the computational difficulty of implementing a permutation test when one sample is small and the other is large and is able to perform thousands of permutation tests under these sample-size conditions in just several hours. As a basis for comparison, the only other statistical program of which I am aware that is designed to perform permutation tests under these conditions was written by Professor John Jackson.² Professor Jackson's code is written in the same statistical software language (SAS) as the present invention and when run on the same computer, requires days to perform the same tests on the same data. When benchmarked against each other on the same datasets with approximately 1,500 sample pairs, ranging from 1 to 29 observations for the smaller of the two samples and up to over 6,000,000 observations for the larger of the two samples, the code of the present invention took 2.02 hours to complete the tests, and Professor Jackson's statistical program took 38.26 hours to complete the tests. In terms of CPU time, the respective runtimes were 1.41 hours and 35.77 hours. ² Jackson, Professor John, Using Permutation Tests to Evaluate the Significance of CLEC vs. ILEC Service Quality Differentials, included in his affidavit on behalf of MCI-Worldcom before the Michigan Public Service Commission, 1998.

Moreover, Professor Jackson's statistical program contains at least two serious flaws: a) under some circumstances, it enters an infinite loop when the number of combinations of possible samples is less than K, the number of permutation sample pairs drawn when the total number of possible sample pair combinations is greater than K (described below); and b) it does not implement a permutation test as an exact test, but rather attempts to split ties at the boundary. As those of skill in the art will know, splitting ties at the boundary results in an anti-conservative test, i.e., one with a size greater than α, the significance level specified by the user/researcher. However, even this is done incorrectly in Professor Jackson's. The code fails to explicitly check for ties, but if ties with the statistic of the original sample pair do exist, they are neither evenly split above and below the critical value (i.e. between the tail and the body of the distribution of statistics from the permutation samples) nor are they all placed beyond the critical value into the tail of the distribution where they would be included in the p-value (as should be done to implement an exact test). Instead, they are all placed in the body of the distribution before the critical value, resulting in an incorrectly deflated p-value and an elevated probability of a Type I error (incorrectly rejecting the null hypothesis). Finally, for reasons unknown, Professor Jackson's code assumes a tie of one observation with the statistic of the original sample pair (when none or more than one may exist), and adjusts the p-value accordingly.

Unique aspects of the present invention described herein that contribute to its speed and make it a new, effective, and viable method for conducting permutation tests when at least one of the two samples being compared is large include:

1. Use of Non-duplicate Permutation Sampling to Maximize Statistical Power

To the extent that a permutation test utilizes duplicate permutation sample pairs (i.e. the same sample pair is drawn more than once), it loses statistical power. Generating a unique set of permutation sample pairs, however, can dramatically and prohibitively increase the computer runtime required to implement a permutation test because if drawn sequentially, each sample must be compared to all previously-drawn samples, and then discarded if it is a duplicate and another drawn and similarly compared. This code has been designed to generate a unique set of permutation sample pairs, with a negligible increase in overall runtime, on virtually any pair of data samples, thus maximizing the statistical power of the test. When generating K pairs of samples, and the likelihood of selecting duplicate samples is high given the number of possible sample-pair combinations and the size of K, the code “over samples,” generating X*K sample pairs (where X is determined by the probability of a draw of K sample pairs having no duplicates, as described below). Duplicates are deleted from the X*K sample pairs, and of the remaining sample pairs, K pairs are selected randomly. Since the selection of these K sample pairs is random, and the probability of selecting any of the sample pairs remains equal (a requirement of a non-parametric permutation test), such “over sampling” is a valid method of obtaining a set of sample pairs with no duplicates. Selecting the additional sample pairs does not noticeably slow the code—it is the redrawing of the X*K sample pairs when they do not yield at least K unique samples that increases runtime. However, this does not increase runtime appreciably overall as this occurrence is very rare.

For example, define N as the total number of possible sample pair combinations according to the mathematical formula N=n!/[(n1−n2)!n2!], where n1 is the number of data points in the first sample and n2 is the number of data points in the second (or third or fourth, etc.) data sample, and ! represents the factorial function (e.g. 4!=4*3*2*1=24). The probability of obtaining a unique set of permutation sample pairs, P, when K=1,901, and N=392,792 is (approximately) P=0.01 based on the mathematical formula P=[N!/(N−K)!]/Nˆ K. Consequently, when P<=0.01, this code generates the full set of all sample-pair combinations and randomly selects K unique pairs from this fully enumerated set. Otherwise, if 0.01<P<=0.05, the code randomly selects 3*K sample pairs, deletes any duplicates, and randomly selects K unique pairs from this set. If fewer than K unique pairs exist amongst the 3*K pairs, another set of 3*K pairs is drawn. If 0.05<P<0.50, 2*K sample pairs are drawn, and if 0.50<P, (1.5*K+0.5) sample pairs are drawn.

2. Use of “Adaptive Merging”

There are different methods of merging data—joining multiple records from two or more datasets into (typically) a single record. Two relevant methods in SAS include a) the combination of PROC SORT and a MERGE statement in a data step, and b) the combination of indexing a dataset and using PROC SQL. The efficiency of each method depends on the specific size and structure of the datasets being merged, as well as the number of variables by which the datasets are being merged. As a consequence, this code implements “adaptive merging”—when facing a potentially time-consuming data merge, the code checks the number of “by variables” being used in the merge to select a fast and efficient method for those particular datasets. Because the number of “by variables” will vary as the code is implemented from test to test, an adaptive merging capability appreciably reduces the typical runtime required by the program. In the preferred embodiment of the present invention utilizing the SAS programming language, the largest and only merge in the code where “adaptive merging” is required is the merge of 1) the multiple permutation sample pair sets which contain for one (usually the smaller) sample of each permutation sample pair randomly selected ordinal numbers associated with each observation in the original pooled dataset, and 2) the pooled sample of the original sample pair containing the actual sample values (not just the ordinal numbers associated with them). The merged dataset almost always contains the smaller of the two samples from every permutation sample pair, and every set of permutation sample pairs (just the one sample of each pair) associated with each of the original sample pairs.

However, when calculating the statistics associated with each permutation sample pair, both samples in the pair are needed, not just the smaller of the two. Yet summary statistics of the second (usually larger) sample can be computed with a combination of the summary statistics from the smaller sample, and the summary statistics of the pooled sample, which can be merged on to these results very quickly. For example, if the original sample pair consisted of a sample with 5 observations and a sample with 100,000 observations, the code does not generate K permutation samples, each 100,000 observations in size—it generates K permutation samples, each 5 observations in size. However, the sum of each sample in each pair is required for calculating and rank-ordering the results, for example, of a pooled-variance t-test. But the sum of the 100,000-observation permutation samples can simply be calculated from the difference between the pooled sum and the sum of each corresponding 5-observation permutation sample in each sample pair. Standard deviations can be similarly calculated. Thus using the smaller of the two original samples, combined with the pooled-sample summary statistics, when generating statistics of all the permutation sample pairs decreases computer runtime and, in fact, makes these necessary calculations possible when in many instances they would not be on all but the largest computers.

3. Uses of Looping and Avoiding Unnecessary Looping

Permutation tests generate and utilize many samples randomly drawn from the two data samples being compared. This repeated sampling, and the repeated calculations associated with it, lends itself to looping in the code, but sometimes looping is an inefficient method of carrying out repeated tasks.

3.1. Use of Sampling Procedure to Avoid Unnecessary Looping

The present invention utilizes a specific sampling procedure (PROC PLAN) built into the SAS programming language to avoid repetitive and time-consuming looping on the data and quickly generate a large number of permutation samples. However, this code customizes the implementation of this procedure with a nested macro, making it at least several times faster than another pre-programmed sampling procedure (PROC MULTTEST) specifically designed for the purpose of generating multiple samples. This code also has been designed to avoid a numeric sample size limitation of PROC PLAN that otherwise would make it unusable for very large samples. Define N as the number of possible combinations of the two data samples according to the mathematical formula N=n1!/[(n1−n2)!n2!], where n1 is the number of data points in the first sample and n2 is the number of data points in the second (or third or fourth, etc.) data sample, and ! represents the factorial function (e.g. 4!=4*3*2*1=24). PROC PLAN will not function when [(n1+n2)*(# draws)]>2ˆ 31, where # draws=K (or some multiple of K, X*K, as explained below). However, the code implements a nested macro that calls PROC PLAN ceil([(n1+n2)*(# draws)]/(2ˆ 31)) times (where “ceil” is a ceiling function rounding to the next highest integer, e.g. if ([(n1+n2)*(# draws)]/(2ˆ 31))=1.1, the nested macro calls PROC PLAN twice), each time generating ceil([(n1+n2)*(# draws)]/(2ˆ 31))sample pairs, until K sample pairs have been generated, where K the number of permutation sample pairs generated according to the mathematical formula K=min(N, [α(1-α)]/CVˆ 2), where CV is the coefficient of variation of the p-value (the result of the permutation test described above); and α is the significance level of the test (typically α=0.05). When N>1,901, the recommended value of K=1,901 ensures that, for α=0.05, CV<0.10 which, like α=0.05, is an appropriate value for CV.

3.2. Use of Other Procedures to Avoid Unnecessary Looping

Several other procedures in the SAS programming language are designed to perform multiple calculations and operations simultaneously on the same, and even different sets of variables. For example, PROC SUMMARY and PROC MEANS can be used when many variables need to have the same, and even different statistical calculations (average, standard deviation, sum-of-squares, etc.) performed upon them; PROC TRANSPOSE can be used when many variables in a dataset that has just been put through PROC SUMMARY, for example, need to be transposed into a single column (variable), for any number of reasons, such as the need to merge it with a similarly structured dataset. Wherever more efficient, the present invention described herein takes advantage of these built-in characteristics of the language to avoid what would otherwise require time-consuming looping.

3.3. Use of Strings to Avoid Unnecessary Looping

After drawing multiple permutation samples, the present invention combines many datasets (to date, thousands at a time) into a single dataset. Constructing such a dataset cumulatively in a loop is prohibitively time-consuming (each loop will take longer than the last). An alternative—placing all the dataset names in a string and using the string to combine them all at once—is not possible in older (v6.12 and earlier) versions of the SAS language as the string almost always becomes too long. This code is designed to circumvent this string-size limitation by quickly combining strings of strings by a) using nested loops within a subsequent data step to create the strings containing the dataset names of the generated permutation samples, and placing these strings into strings of strings in global variables using the “call symput” function; and b) using a “set” statement in a data step to combine all the global variables, and thus, all the datasets, together into a single, large dataset.

3.4. Use of Macros to Perform Looping Efficiently

When looping is unavoidable or faster than any alternatives, this code relies heavily upon macros—a method of performing similar operations or data manipulation on multiple datasets. When combined with procedures and data steps to effectively avoid inefficient and unnecessary looping, macros are the quickest way to carry out repeated tasks on multiple samples of data. The nested macros in the code enable the use of the fastest available sample-generation procedure in the SAS language (PROC PLAN) and allow for its use where it would be otherwise unusable (when N>2ˆ 31).

3.5. Use of Arrays to Perform Looping Efficiently

When multiple variables within a dataset require similar calculations, manipulation, or tests, combining them into an array and then performing loops on these arrays can be the fastest method for performing the required tasks.

Whenever most efficient, this code makes use of arrays.

4. Use of Method to Correctly Handle Permutation Samples with a Variance of Zero

This code allows the user to select from among several different statistics when implementing the permutation test, but some of these (e.g. the “modified” Z-test—see Brownie, et al, Modifying the t and ANOVA F tests When Treatment is Expected to Increase Variability Relative to Controls, Biometrics, March, 1990, and Blair, R. Clifford and Shlomo Sawilowsky, Comparison of Two Tests Useful in Situations where Treatment is Expected to Increase Variability Relative to Controls, Statistics in Medicine, Vol. 12, 2233-2243, John Wiley & Sons, Ltd., 1993), cannot be calculated when one of the two samples being compared (that which has its variance is in the denominator of the Z-statistic—typically the larger) has a variance of zero. However, even if the variance of that sample of the original two data samples being compared is not equal to zero, a permutation test often can generate permutation samples that have variances equal to zero: yet the selected statistic still must be calculated for each of these samples. In such circumstances, this code is designed to still correctly implement the permutation test by creating exceedingly large or small values for the test statistic (999 or −999), depending on whether the difference in means is positive or negative, respectively.

5. Use of Code Allowing User to Select From a Range of Possible Statistics

A permutation test can be implemented using a variety of statistics, and the appropriateness of each may be determined by the data and the conditions of the test. This code permits the user to select from among several statistics, including, for continuous data, both the pooled-variance and separate-variance t-tests, and the “modified” Z-test, and for count data, a normal approximate Poisson test. This flexibility is highly useful when hypothesis tests need to be applied to different variables in the same dataset comprised of different types of data (e.g. count data vs. continuous data). The different data types dictate the use of distinct statistics, yet other software designed to perform limited permutation testing (e.g. PROC MULTTEST, or Professor Jackson's code) provides no choice of a test statistic.

While the invention has been disclosed in connection with the preferred embodiments shown and described in detail, it will be understood that the invention is not to be limited to the embodiments disclosed herein. For example, the invention may be applied to a wide range of contexts requiring two-sample statistical hypothesis tests of continuous- or count-variable means in addition to the telecommunications industry. The invention may be further understood from the following claims, which are to be interpreted as broadly as allowed under the law.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A process for comparing two data samples, comprising
(a) obtaining a first data sample having a first number of data points,
(b) obtaining a second data sample having a second number of data points,
(c) processing the first and second data samples to determine respective measures of either observed means and the difference between the observed means, observed sums and the difference between the observed sums, or a t-statistic or a Z-statistic,
(d) selecting data points from the first data sample and the second data sample to generate a plurality of sample pairs combining data points from the first and second data samples and having a number of data points comparable to the numbers in the first data sample and the second data sample,
(e) calculating and ranking t-statistics, Z-statistics, or differences in means or sums from the generated pairs of samples, and
(f) calculating a p-value by determining a percentage representative of the percentage of the t-statistics, Z-statistics, or differences in means or sums of the generated sample sets that are as large as those of the original sample pair.

2. A process according to claim 1, wherein the number of data points in the first data sample is insufficient to apply the Central Limit Theorem.

3. A process according to claim 1, including obtaining additional sample pairs and repeating the steps of b-f, for each additional sample pair, for determining a percentage representative of the percentage of the t-statistics, Z-statistics, or differences in means or sums of each of the sets of generated pluralities of sample pairs that are as large as those of the corresponding original sample pairs.

4. A process according to claim 1, wherein selecting data samples to generate a plurality of sample pairs includes determining a statistically appropriate number of generated sample pairs to generate according to the mathematical formula K=min(N, [α(1−α)]/CVˆ 2), where K is the number of sample pairs generated; CV is the coefficient of variation of the p-value; α is the significance level of the test; and N is the number of possible sample pair combinations based on the original sample pair.

5. A process according to claim 1, wherein selecting data samples includes applying a random sampling procedure to select data points from both samples of each pair for the purpose of generating respective pluralities of data sample pairs from the combined points of each original sample pair.

6. A process according to claim 5, wherein a nested macro is used to overcome a numeric size constraint of the random sampling procedure used to select data points from both samples of each original sample pairs.

7. A process according to claim 1, wherein generating a plurality of data sample pairs based on the combined data points of each original sample pair includes generating a respective set of unique sample pairs containing no duplicates via “over sampling” wherein X*K sample pairs are created (X being determined by the probability of drawing K unique sample pairs given K and N, the number of possible sample pair combinations) and wherein duplicates are deleted from the X*K sample pairs, and of the remaining sample pairs, K pairs are selected randomly.

8. A process according to claim 1, wherein pre-programmed utilities for performing multiple operations simultaneously are identified in the SAS statistical programming language and used to reduce computational time.

9. A process according to claim 1, wherein selecting data samples includes generating a string of strings of dataset names to combine quickly and efficiently the large number of data samples.

10. A process according to claim 1, wherein merging data includes identifying characteristics of the merge and selecting a merging method for reducing computer runtime for merging the data.

11. A process according to claim 1, including identifying portions of the process that require multiple iterations through a series of programmed steps and substituting macro calls and nested macro calls for the expanded series of in-line steps.

12. A process according to claim 1, including identifying portions of the process that require multiple iterations through a series of programmed steps and substituting loops performed on an array of multiple variables for the expanded series of in-line steps.

13. A process according to claim 1, processing the first and second samples of the original sample pairs to generate one of several test statistics selected by the user from the group consisting of the pooled-variance t-test, the separate-variance t-test, the “modified” Z-test, and a normal-approximate Poisson test.

14. A process according to claim 1, wherein selecting data samples from every original sample pair includes testing the generated sets of sample pairs to identify those with samples (typically the larger of the two samples) having a variance of zero.

15. A process according to claim 14, that correctly implements a permutation test based on the test statistic selected by the user, even if that statistic, to be calculated, requires variances greater than zero.

16. A system for comparing two data samples, comprising:
a data memory having storage for a first sample having a first number of data points, and for a second data sample having second number of data points, included in a dataset containing a number of additional data sample pairs,
a data sample generator for selecting pairs of data samples from data points from both the first sample and second sample, and any additional original sample pairs, from among the datasets containing the combined data points of each pair, to generate respective pluralities of sample pairs, being a combination of the data points from the first and second samples of each pair, and having a number of data points comparable to the numbers in the first and the second samples of each pair,
processes for reducing computational time when generating and processing pairs of data samples, the processes selected from the group consisting of “oversampling” to avoid duplicate sample draws and maximize statistical power, use of nested macros with a pre-programmed sample-generation procedure to avoid a numeric size limitation, use of macros and nested macros, arrays, looping, “adaptive” merging, strings, and pre-programmed procedures that perform multiple operations simultaneously,
a statistical processor for processing the data sample pairs and for processing the generated sets of corresponding sample pairs to implement a user-specified test statistic suitable for testing a null hypothesis, and
means for determining as a function of the generated test statistic whether the null hypothesis of no difference between the two populations of data may be rejected.

17. A system according to claim 16, wherein the data sample generator includes a random sampling process to select pairs of data samples based on the data points in both the first and second samples in each original sample pair, for generating respective pluralities of data sample pairs.

18. A system according to claim 16, including a process for generating a unique set of sample pairs by generating more sample pairs than required and deleting duplicates, thus maximizing the statistical power of the permutation test.

19. A system according to claim 16, including a data merging process for identifying characteristics of the merge and selecting a merging method as a function of said identified characteristics to thereby reduce computer runtime required for merging the data.

20. A system according to claim 16, including a process for testing generated sample pairs to identify whether one (typically the larger) sample of the pair has a variance of zero.

21. A system according to claim 16, including a process that calculates and uses a test statistic according to a user-selection from among several possible test statistics, even when the variance of one of the samples of the sample pair is zero and the test statistic requires a non-zero variance to be calculated

22. A computer readable medium having stored thereon instructions for directing a data processing system to compare two data samples, the instructions comprising obtaining a first data sample with a small number of data points, obtaining a second sample with a large number of data points, and any number of additional similarly-sized sample pairs, processing the data sample pairs to determine respective measures of user-specified statistics (t-statistics, Z-statistics, and sometimes simply the differences between the observed means or sums), selecting data samples from the first and second sample of each sample pair to generate respective pluralities of sample pairs, each sample of each generated pair being a combination of data points from the first and second samples of the original pair and each pair of samples having a number of data points identical to the numbers in the first sample and the second sample of the original pair, calculating and ranking t-statistics, Z-statistics, or differences in means or sums for the set of generated sample pairs for one original sample pair, and calculating a “p-value” by determining a percentage representative of the percentage of the statistics or differences in means or sums of the set of generated sample pairs that are as large as that of the original sample pair, and repeating this process for each original sample pair.
